(19) United States
(12) Patent Application Publication
(10) Pub. No.: US 2018/0276244 A1
(43) Pub. Date: Sep. 27, 2018

(54) METHOD AND SYSTEM FOR SEARCHING FOR SIMILAR IMAGES THAT IS NEARLY INDEPENDENT OF THE SCALE OF THE COLLECTION OF IMAGES

(71) Applicant: COMMISSARIAT A L'ENERGIE ATOMIQUE ET AUX ENERGIES ALTERNATIVES, Paris (FR)

(72) Inventors: Adrian POPESCU, Montrouge (FR); Herve LE BORGNE, Paris (FR); Alexandru Lucian GINSCA, Montrouge (FR); Etienne GADESKI, Orsay (FR)

(73) Assignee: COMMISSARIAT A L'ENERGIE ATOMIQUE ET AUX ENERGIES ALTERNATIVES, Paris (FR)

(21) Appl. No.: 15/763,347

(22) PCT Filed: Sep. 27, 2016
(86) PCT No.: PCT/EP2016/072922

§ 371 Date: Mar. 26, 2018

(30) Foreign Application Priority Data
Sep. 30, 2015 (FR) 15 59289

(51) Int. Cl. G06F 17/30

(52) U.S. Cl. CPC G06F 17/30256; G06F 17/3053; G06F 17/30271; G06F 17/3028

(57) ABSTRACT

A method for searching for images similar to a query image in a collection of images, using a representation of the query image in a form of a vector of characteristics allocating a weight to each of the characteristics, and including querying an inverted index matching each of the characteristics with images from the collection. The querying the inverted index includes integrating, into a list, one or more images from the collection that are matched in the inverted index with a first characteristic selected depending on the weight allocated to same in the vector representing the query image. The integrating into the list is repeated for another characteristic selected depending on the weight allocated to same in the vector representing the query image until the number of images of the collection integrated into the list reaches a target number.

### TECHNICAL FIELD

The field of the invention is that of the data mining, and more particularly that of image search by the content for which images similar to a purely visual request taking the form of an image called a request image are desired to be retrieved.

### STATE OF PRIOR ART

In the absence of text annotations, the image search can be made by means of request images which are used in order to retrieve similar images within a collection of reference images.

This visual similarity based search process comprises two main phases, indexing the collection of images, which is carried out offline, and requesting, which should be made online. The purpose of indexing is to transform the “pixelic” content of the images into vectorial representations by features (feature extraction), generally with a fixed size. The purpose of the requesting step is to extract a vectorial representation of the content of the request image and to compare it to the representations of the images from the collection in order to retrieve the most similar elements.

The vectorial representations of the visual features include:
the representations which aggregate local descriptors within a fixed-size vector (i.e. bags of visual words, Fisher vectors, convolutional neural networks, etc.);
the representations which encode global features (i.e. colour histograms, texture descriptions, etc.);
the semantic representations which are obtained by aggregating intermediate classifiers and which give probabilities of occurrence of individual concepts in the image.

An important problem in similarity based image search is the quickness of the search which has to be performed “online”. This problem comes to be crucial when the aim is to process large scale collections (i.e. billions of images). There are three main solutions which enable the similarity based search process to be accelerated:
the reduction in the size of the vectorial representations by using techniques such as principal component analysis, linear discriminant analysis, vectorial quantisation, etc.;
the use of search trees (kd-trees, k-means trees, random forests) which operate by partitioning the search space defined by the vectors representative of the images and thus enable the image search process to be accelerated;
the representation by inverted files which is inspired by text document search and is efficient if the vectors representing the images from the collection are hollow (sparse). This structure type associates with each dimension of the representation space, a set of documents and, in view of the hollow character of the representations, the similar documents are retrieved more efficiently by comparing all the non-zero dimensions of the vector representing the request document with the documents from the collection which are associated with these dimensions.

In spite of their improved efficiency with respect to exhaustive comparisons of the representative vectors, the use of these accelerated search methods always requires making a set of mathematic operations to make similarity calculations between the vector representing the request image and the vectors representing the images of the collection. Searching for similar images thus remains complex, and this complexity increases with an increasing collection size.

### DISCLOSURE OF THE INVENTION

The invention aims at providing an image search technique by the content which is simpler to implement but without losing relevancy, and which enables it to be applied to very large size reference collections without dramatically increasing the search time.

To that end, the invention provides a method for searching for images similar to a request image in a collection of images, which method makes use of a representation of the request image by a feature vector associating a weight with each of the features, and comprising a step of querying a reverse index matching each of the features with images from the collection. The step of querying the reverse index comprises an operation of integrating to a list one or more images of the collection matched in the reverse index with a first feature selected depending on the weight associated therewith in the vector representing the request image. The operation of integrating to the list is repeated for another feature selected depending on the weight associated therewith in the vector representing the request image as long as the number of images from the collection which are integrated to the list has not reached a target number.

Some preferred but non-limiting aspects of this method are the following ones:
the step of querying the reverse index starts with an operation of integrating to the list having as a first feature the highest weight feature in the vector representing the request image, and continues as long as the number of images integrated to the list has not reached the target number by repeating the operation of integrating to the list with as another feature, the immediately lower weight feature in the vector representing the request image;
the operation of integrating to the list is made so as to integrate an image from the collection which is matched with a feature in the reverse index only if said image has not been already integrated to the list;
it comprises a step of determining, from the target number of images in the list, and for each feature, a maximum number of images that can be integrated to the list from the images matched with said feature in the reverse index;
it comprises a prior step of indexing the collection of images, comprising:
   for each image from the collection, extracting features of the image to represent the image as a feature vector associating a weight with each of the features;
   for each feature, ordering the images from the collection depending on their weight associated with the feature to create a list of images ordered by decreasing weight;
   creating the reverse index by matching each of the features with a predefined number of images from the collection corresponding to the first images in the list of ordered images which are associated with the feature.
the features are features relating to the presence of visual concepts in an image, the vector representing an image having as a weight associated with each of the features a probability of occurrence of a visual concept in the image;
it further comprises a step of ranking the images integrated to the list, said ranking step comprising, for each of the images integrated to the list, measuring a similarity with the request image;
measuring similarity of an image integrated to the list with the request image comprises comparing low-level, respectively high-level, features extracted from the request image and low-level, respectively high-level, features extracted from the image integrated to the list;
it comprises a step of reformulating the vector representing the request image consisting in modifying the weight associated with one or more features that can be mistaken for other features.

The invention is also concerned with a computer program product comprising program code instructions enabling the steps of the method to be performed when said program is executed on a computer. It further extends to a system for searching for images similar to a request image in a collection of images which is configured to implement the method according to the invention.

### BRIEF DESCRIPTION OF THE DRAWINGS

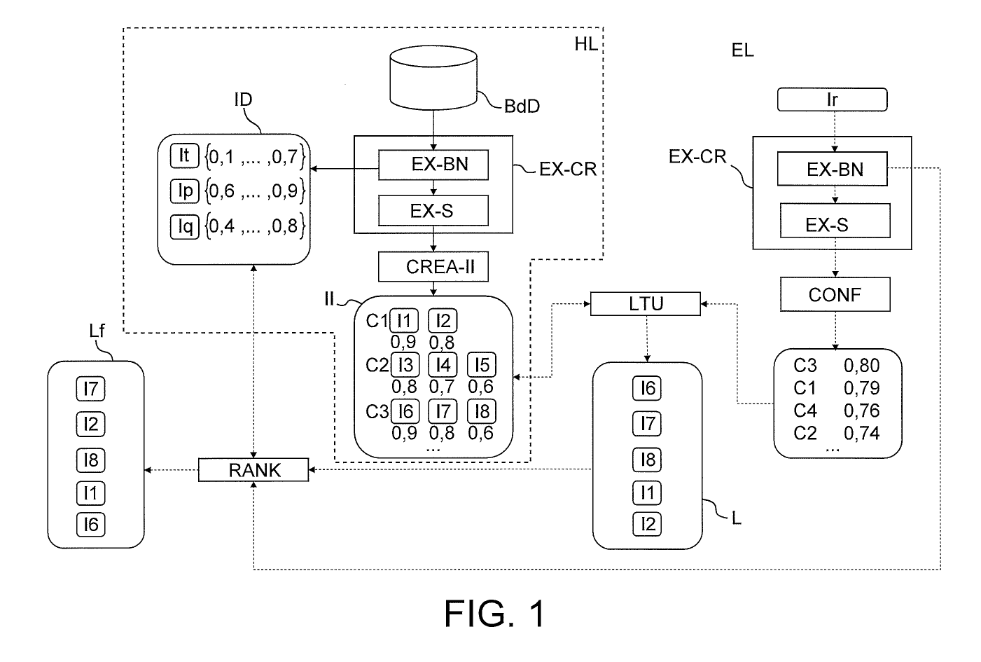

Further aspects, purposes, advantages and features of the invention will better appear upon reading the following detailed description of preferred embodiments thereof, given by way of non-limiting example, and made in reference to the appended FIG. 1 which illustrates the overall scheme of a possible embodiment of the method according to the invention.

### DETAILED DISCLOSURE OF PARTICULAR EMBODIMENTS

The invention is concerned with a method for searching for documents among the documents of a collection by means of a representation of a request and documents from the collection by a feature vector associating a weight with each of the features. In the following, the example of a collection of images will be taken, without this being limiting, the invention aiming at any type of multimedia document and being possibly implemented provided that a representation by feature vector of the multimedia documents is accessible.

The invention is in particular also concerned, but not exclusively, with the search for images similar to a request image from a collection of images which generally comprises thousands of images, or even millions of images. The method has in particular the purpose to create a list of images from the collection which are similar to the request image the number of similar images of which corresponds to a predetermined target number x. It makes use of a representation of the request image by a feature vector associating a weight with each of the features, and comprises a step of querying a reverse index matching each of the features with images from the collection.

The method is comprised of two main phases: a so-called indexing first phase generally performed “off line”, and a requesting second phase generally performed “online”, that is in real time during the actual similar image search.

FIG. 1 represents a global scheme of the method according to the invention. In this figure, the solid lines illustrate the steps performed “off line” whereas the dotted lines illustrate the steps performed “online”. In this same figure, the data and processing results are represented with rounded-corner rectangles, the different steps of processing data being shown in rectangles. In this figure, the steps and data of the offline HL indexing phase have been separated from the steps and data of the on line EL search phase.

Each of the first and second phases HL, EL includes a step of extracting features “EX-CR” (feature extraction) of an image to represent the image as a feature vector associating a weight with each of the features of a set of image features.

During the indexing phase HL, the feature extraction EX-CR is implemented for all the images from the collection which are stored in a database BdB. During the online EL search phase, the feature extraction EX-CR is implemented for the request image Ir. The images from the collection and the request image are thus described by a vector of the same nature.

In a possible embodiment of the invention, the feature extraction of an image EX-CR comprises a low-level feature extraction “EX-BN” which enables a fixed-size vector to be associated with the image, followed by a high-level feature extraction “EX-S” from the low-level features. The low-level features are typically hardly interpretable features, whereas the high-level features are generally understandable by humans.

The low-level features are for example bags of visual words (BoVW), histograms of oriented gradients (HOG), Fisher kernels, fully connected layers (called “classification” layers) of convolutional neural networks, etc.

These low-level features can be stored in a direct index ID which associates with each of the images from the collection It, Ip, Iq, the fixed-size vector resulting from the extraction of low-level features of the image.

The high-level features are for example visual features enabling a semantic representation of the image to be formed.

This can be an intermediate semantic representation (the features being for example the outputs of the final layer of a convolutional network) or an actual semantic representation (in this case, the features are related to the presence of visual concepts in the image, the vector representing an image having as a weight associated with each of the features, a probability of occurrence of a visual concept in the image). Such a semantic representation is typically obtained by aggregating the outputs of a bank of visual classifiers which provide probabilities of occurrence of individual concepts in the image. It makes it possible to search for images similar to a request formulated with text concepts of the representation space in place of request images.

It will be observed that when the reference collection includes images from a specifie field, it is possible to adapt the representation space by removing features which are not relevant within the context.

After extracting features from an image, a compact representation of the image is available as a fixed-size vector which can be written as Dₖ={(v₁, p₁^{k}), (v₂, p₂^{k}), . . . , (vₙ, pₙ^{k})} where vᵢ are the dimensions of the representation vectorial space and pᵢ are the weights associated with these dimensions for the image considered. The vᵢs can thus represent a set of visual concepts, pᵢ being the probability of presence of the visual concept vᵢ in the image.

Assuming intuitively that only a reduced number of visual concepts is recognisable in an image and should thus be active in the vector representing an image, one can attempt to obtain a sparse (or “hollow”) representation of the image comprising a reduced number of non-zero dimensions in the vector representing the image. To do this, the vector D representative of an image is modified such that only a small sub-set k of the weights pᵢ remains non-zero. Typically, there is k≤10 and the vector representing an image is rewritten as:

Dₖ={(v₁, p₁^{k}), (v₂, p₂^{k}), . . . , (vₙ, pₙ^{k})},

where all the weights p″ beyond the greater k are all zeroed.

This sparse representation enables a great amount of information to be encoded on a low number of dimensions, and enables to make indexing with an inverted file more efficient as has been demonstrated in the paper by A. Ginsca, A. Popescu, H. Le Borgne, N. Ballas, P. Vo, and I. Kanellos entitled “Large-scale image mining with Flickr groups” in Proc. of Multimedia Modelling Conf. 2015.

The prior phase of offline indexing HL comprises, as has been previously seen, for each image from the collection, extracting features EX-CR of the image to represent the image as a vector associating a weight with each of the image features. Then, it comprises creating “CREA-II” a reverse index II matching each of the features with a predefined number of images from the collection. By retaining a predefined number of images associated with each of the features, the memory footprint of the reverse index can be limited.

This predefined number can be identical for all the features or conversely, specific to each feature. It can be arbitrary (for example only 1000 images, at most, are retained per feature) or be elaborated as a function of the target number x of images in the list of similar images by determining, for each feature, a maximum number of images that can be integrated to the list. This maximum number of images can be the same for each of the features or not.

In a possible embodiment enabling the relevance of the results to be maximised, the feature extraction EX-CR is followed by an operation of ordering, for each of the features, the images from the collection depending on their weight associated with the feature to create a list of images ordered by decreasing weight. And then, an operation of creating “CREA-II” the reverse index II is made which matches each of the features with a predefined number of images from the collection corresponding to the first images in the list of ordered images which are associated with the feature. In the reverse index II, xᵢ images associated with the feature vᵢ are thus retrieved, these xᵢ images having a weight pᵢ associated with a non-zero feature in the vectors representing them. This predefined number xᵢ can in particular, but not necessarily, correspond to the maximum number of images that can be integrated to the list of similar images which is determined depending on the target number x of images in the list of similar images.

In the example of FIG. 1, the reverse index II thus matches:
the feature C1 with the images I1 and I2 from the reference collection, whose weights associated with this feature are respectively 0.9 and 0.8;
the feature C2 with the images I3, I4 and I5 from the reference collection, whose weights associated with this feature are respectively 0.8, 0.7 and 0.6;
the feature C3 with the images I6, I7 and I8 from the reference collection, whose weights associated with this feature are respectively 0.9, 0.8 and 0.6.

It will be reminded that, depending on the frequency of occurrence of the feature vᵢ in the collection, the number xᵢ of images from the collection which are associated with this feature can be lower than the target number of images x in the list of similar images.

The on line EL search phase comprises, as has been previously seen, extracting features EX-CR of the request image to represent the request image as a vector of the same type as those representing the images from the reference collection.

In a possible embodiment of the invention, the online search phase comprises a step of reformulating “CONF” the vector representing the request image consisting in modifying, for example in increasing, the weight associated with one or more features that can be mistaken with one or more features selected depending on the weight associated therewith in the vector representing the request image (typically, the highest-weight features are selected). This reformulating step can make use of a confusion matrix which senses, for each feature vⱼ, a probability that it is mistaken with features vⱼ. This matrix is calculated on a learning base (which can be independent of the collection) the ground true of which is given by text annotations of the target features vᵢ. Given an image annotated with vᵢ, it is considered that this dimension is mistaken for vᵢ if the probability associated with the feature vⱼ is higher than that associated with the feature vᵢ. This confusion is averaged on all the learning images of the target feature vᵢ to form the confusion matrix. This matrix thus encodes global relationships of dependency between the features which are obtained by aggregating all the learning images for each dimension vᵢ.

Such a confusion matrix is generally used to analyse classification faults. Within the scope of the invention, a positive role is given to the confusions and the confusion matrix is used in order to diversify the representation of the request image by considering not only the features associated with the highest probabilities in the vector representing the request image, but also a set of features with which it is probable that these features associated with the highest probabilities are mistaken.

In an alternative to this embodiment of reformulating the vector representing the request image, an operation of merging the initial vector (resulting from the feature extraction EX-CR) and the vector reformulated by means of the confusion matrix is further conducted. This merging can be implemented, for example, by successively choosing dimensions included in each of both vectorial representations. The usefulness of merging is given by the fact that the initial vector encodes a vectorial representation specific to the image whereas the reformulated vector encodes a representation which is based on more generic relationships between the vector dimensions.

In what follows, the same term of vector representing the request image will be used to designate both the initial vector and the reformulated vector or the vector from merging.

An example of vector representing the request image is given in FIG. 1, after ordering the features depending on their weight. This vector thus indicates for a first feature C3 a weight of 0.80, for a second feature C1 a weight of 0.79, for a third feature C4 a weight of 0.76, for a fourth feature C2 a weight of 0.74, etc.

The search phase is continued with a step of querying LTU the reverse index II to create a list L of images from the collection I6-I8, I1, I2 similar to the request image Ir. This list contains a number of similar images which corresponds to a predetermined target number x (x=5 in the example of FIG. 1). This list is returned as a reply to the request based on the request image.

The step of querying LTU the reverse index more particularly comprises a step of integrating to the list one or more images I6-I8 from the collection matched in the reverse index II with a first feature C3 selected depending on the weight associated therewith in the vector representing the request image, the operation of integrating to the list being repeated for another feature C1 selected depending on the weight associated therewith in the vector representing the request image as long as the number of images integrated to the list has not reached the target number x.

This querying step LTU only involves an iteration on the dimensions vᵢ of the vector representing the request image until the x similar images requested have been retrieved. This querying form, depending on the search purpose, accelerates the search process with respect to the methods of the state of the art.

Preferably, the step of querying the reverse index starts with an operation of integrating to the list having as a first feature, the highest-weight feature C3 in the vector representing the request image, and is continued as long as the number of images integrated to the list has not reached the target number by repeating the operation of integrating to the list with as another feature, the immediately lower-weight feature in the vector representing the request image.

Taking the example of FIG. 1, and a target number x=5, the querying step comprises a first operation of integrating to the list the images I6-I8 associated with the feature C3 in the reverse index II, this feature being the strongest weight one in the vector representing the request image. A second operation of integrating to the list is then made to integrate to the list the images I1-I2 associated with the feature C1, which is the immediately lower weight one in the vector representing the request image.

The list of similar images L is thus obtained by concatenating the lists of the reverse index which are associated with the strongest-weight features vᵢ in the vector representing the request image. No arithmetic operation is necessary, except for the removal of possible duplicates, an operation of integrating to the list being actually made so as to integrate an image from the collection only if said image has not been already integrated to the list. This process considers each of the features of the vector representative of the request image independently (one feature by operation of integrating to the list) and is thus nearly independent of the size of the reference collection, which is not true in any requesting methods of the state of the art.

In a possible embodiment, all the images matched in the reverse index with a strong-weight feature vᵢ in the vector representing the request image are integrated to the list of similar images L. Alternatively, only a part of the images matched in the reverse index with a strong-weight feature vᵢ representing the request image is integrated to the list of similar images. This alternative can turn out to be useful to attenuate the possible negative effects of a wrong association of a feature vᵢ with the request image, and to avoid promoting too much the integration of images matched with the strongest-weight features. It can in particular be implemented when the predefined number of images matched in the reverse index with a feature vᵢ corresponds to the maximum number of images that can be integrated to the list determined depending on the target number x of images in the list of similar images.

In a possible embodiment of the invention represented in FIG. 1, it is possible to reorder the similar images integrated to the list at the end of the querying step LTU of the inverted file II by making a finer comparison of the request image and the images integrated to the list of similar images L. The method can thus comprise a step of ranking “RANK” the images integrated to the list of similar images L, said ranking step comprising, for each of the similar images integrated to the list, measuring a similarity between the request image and the similar image. The images of the list of similar images L are then reordered and integrated to a refined list Lf depending on their similarity with the request image.

The computing complexity of this comparison only depends on the size x of the list of similar images and a suitable choice of this size enables the refined list of results Lf to be accessed in real time.

On the other hand alternatively, the ranking step RANK can be applied to a restricted number of images from the list of similar images L For example, if the ranking is restricted to the first three images in the preceding example, the final list Lf could be I7, I8, I6, I1, I2 because only I6, I7 and I8 are re-ranked.

Measuring a similarity can in particular be made by making use of the vectorial representations of the request image and images from the list of similar images, in particular, as has been represented in FIG. 1, the low-level features extracted from the request image and the low-level features extracted from the images of the list of similar images which are stored in the direct index ID. In an alternative embodiment, measuring a similarity can also be made by making use of the high-level features of the images (typically semantic representations) in their hollow, or full versions. By way of illustrating examples, measuring a similarity can be measuring a cosine similarity or measuring the Euclidien distance L².

The invention is not limited to the method as previously described but is also applicable to a computer program product comprising program code instructions enabling the steps of the method to be performed when said program is executed on a computer. The invention is also concerned with a system for implementing the method, and in particular with a system for searching for images similar to a request image in a collection of images making use of a representation of the request image by a feature vector associating a weight with each of the features, comprising:

a database BdB in which the collection of images and a reverse index II matching each feature of a set of image features with images of the collection are stored;

a processor configured to query the reverse index in order to create a list of images from the collection which are similar to the request image by making an operation of integrating to the list one or more images from the collection which are matched in the reverse index with a first feature C1 selected depending on the weight associated therewith in the vector representing the request image, and by repeating the operation of integrating to the list for another feature C2 selected depending on the weight associated therewith in the vector representing the request image as long as the number of images integrated to the list has not reached a target number.

This system typically comprises a communication interface enabling data to be received from a user (in particular the request image) and data to be shown to a user (in particular the images integrated to the list L of images from the collection which are similar to the request image).

1-14. (canceled)

15. A method for searching for images similar to a request image in a collection of images, in which the request image is represented by a feature vector associating a weight with each of a plurality of features, the method comprising:
querying a reverse index matching each of the plurality of features with images from the collection to create a list of images of the collection that are similar to the request image,
wherein the querying the reverse index comprises integrating to the list one or more images of the collection matched in the reverse index with a first feature selected depending on the weight associated therewith in the feature vector representing the request image,
the integrating to the list being repeated with another feature selected depending on the weight associated therewith in the feature vector representing the request image as long as a number of images from the collection which are integrated to the list has not reached a target number.

16. The method according to claim 15, wherein the querying the reverse index starts with an operation of integrating to the list having as the first feature a highest weight feature in the feature vector representing the request image, and continues as long as the number of images integrated to the list has not reached the target number by repeating the operation of integrating to the list having as another feature an immediately lower weight feature in the feature vector representing the request image.

17. The method according to claim 15, wherein the integrating to the list integrates an image from the collection only if the image has not been already integrated to the list.

18. The method according to claim 15, further comprising determining, from the target number of images in the list, and for each feature, a maximum number of images that can be integrated to the list from the images matched with the feature in the reverse index.

19. The method according to claim 18, wherein the maximum number of images that can be integrated to the list is same for each of the features.

20. The method according claim 15, further comprising a prior indexing the collection of images comprising:
for each image from the collection, extracting features of the image to represent the image as a feature vector associating a weight with each of the features;
for each feature, ordering the images from the collection depending on their weight associated with the feature to create a list of images ordered by decreasing weight;
creating the reverse index by matching each of the features with a predefined number of images from the collection corresponding to the first images in the list of ordered images which are associated with the feature.

21. The method according to claim 20, wherein, for each of the features, the predefined number of images in the reverse index corresponds to a maximum number of images that can be integrated to the list.

22. The method according to claim 15, wherein the features are related to presence of visual concepts in an image, the feature vector representing an image having as a weight associated with each of the features a probability of occurrence of a visual concept in the image.

23. The method according to claim 15, further comprising ranking the images integrated to the list, the ranking comprising, for each of the images integrated to the list, measuring a similarity with the request image.

24. The method according to claim 23, wherein the measuring a similarity of an image integrated to the list with the request image comprises comparing low-level features extracted from the request image and low-level features extracted from the image integrated to the list.

25. The method according to claim 23, wherein the measuring a similarity of an image integrated to the list with the request image comprises comparing features related to the presence of visual concepts in the request image and features related to presence of visual concepts of the image integrated to the list.

26. The method according to claim 15, further comprising reformulating the feature vector representing the request image consisting in modifying the weight associated with one or more features that can be mistaken for other features.

27. A non-transitory computer readable medium comprising program code instructions enabling the method according to claim 15 to be carried out when the program is executed on a computer.

28. A system for searching for images similar to a request image in a collection of images, the request image being represented by a feature vector associating a weight with each of a plurality of features, the system comprising:
a database in which are stored the collection of images and a reverse index matching each feature of a set of image features with images of the collection;
a processor configured to query the reverse index to create a list of images from the collection which are similar to the request image by integrating to the list one or more images from the collection which are matched in the reverse index with a first feature selected depending on the weight associated therewith in the feature vector representing the request image, and by repeating the integrating to the list for another feature selected depending on the weight associated therewith in the feature vector representing the request image as long as a number of images integrated to the list has not reached a target number.
